(19) United States
(12) Patent Application Publication
(10) Pub. No.: US 2007/0144055 A1
(43) Pub. Date: Jun. 28, 2007

(54) Plastic fishing lure having integral hook reinforcing means

(76) Inventors: Daniel Joseph Warczok, Cohocton, NY (US); Ronald Joseph Boyce, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/317,931

(22) Filed: Dec. 22, 2005

(51) Int. Cl. A01K 85/00

(52) U.S. Cl. 43/42.49; 43/42.24; 43/42.36

(57) ABSTRACT

The lifetime and durability of artificial baits is improved by providing an integral hook holding portion. The hook holding means is a plastic or fibrous ring or a dense polymer region molded integrally with the bait.

### FIELD AND BACKGROUND OF THE INVENTION

The history of fishing is almost as old as history itself. Fishing history dates back to when people of ancient times began fishing for food, when pieces of bone were used as hooks and lengths of vine as line. The oldest known painting of an angler using a rod or staff comes from Egypt and history dates it from about 2000 BC.

Plato and Aristotle mentioned angling in their writings, and gave tips about fishing lines. This evidence is some of the oldest and profound evidence of civilization and culture in the western world. It is reported that in the 3rd century AD, Roman rhetorician Claudius Aelian wrote about Macedonian trout anglers using artificial flies as lures. While it is not known whether further methods were known to the Romans, it is clear that artificial lures were recognized and valued and the foundations of the western world were further refined and developed by the Romans based upon their adaptation of Greek thought and ideals.

A long period of fishing equipment dormancy there followed. Whether the dormancy was caused by the lack of further development, sometimes called the dark ages, or was in fact causative of this bleak period is open to speculation.

The methods and tackle used for fishing evolved slowly through the centuries, and not until the late 15th century did sportfishing as it is now known really begin. This Renaissance was marked in 1496 by the appearance of the book “A Treatyse of Fysshynge wyth an Angle” which provided gave specific details for the first time in English about the use of the fishing rod. Written by Dame Juliana Berners, the prioress of an abbey near Saint Albans, England, the book describes the construction of hooks and rods for angling. Methods for tying tie knots in fishing lines and how to make and use artificial lures and flies to take advantage of the feeding habits of game fish are explained and exemplified by the book and as such were adopted in practice. Juliana's precepts were the basis of angling knowledge in England for the next centuries.

In 1653, English angler Izaak Walton published “The Compleat Angler”, or the Contemplative Man's Recreation, the single most influential book ever published about sportfishing. Walton gazetted the art of making tackle, surveyed basic aquatic biology, and provided an intellectual foundation for recreational angling. Based on a lifetime of observations, Walton's book describes the craftsmanship involved in making fishing tackle and ponders the methods anglers must use to catch game fish. Walton also gives detailed accounts of feeding habits and life cycles of different species. He believed that the true angler is one who fishes for the love of fishing and that catching fish by sporting means is far superior to other methods of fishing.

Since Walton's time, anglers have continually improved their fishing gear, tactics, and knowledge of fish behavior. At the same time, many of the sport's proponents have realized the necessity of protecting fish habitats so that the sport may continue. Notable anglers and writers who have helped to popularize the sport include two Americans: Lee Wulff, whose books contain anecdotes and intricate details about fly fishing, and A. J. McClane, the author of numerous fishing guidebooks.

Through the years, sportfishing has gained many new adherents. In the late 20th century women took up the sport in increasing numbers and the sport has proven itself to be a harbinger of social acceptance and standing. Books by American fly-fishing instructors such as Joan Wulff have resulted in fly-fishing schools, organizations, and specially designed equipment. The unrelenting inclusion of new participants has been an important part of an overall rise in tourism and business associated with sportfishing.

That being said as western civilization has become more remote from the land, as reliance on subsistence relationships to rural lands has increased and as the need to view fishing as a source of nutritional subsistence has diminished, the interest in the sport as a sport has lead to increased interest in artificial lures and baits. Yet the fish remain unchanged. So the interest in having artificial lures and baits provide allurements to the fish has received increased focus.

U.S. Pat. No. 2,776,518 discloses a fish lure which comprises a molded plastic body, including a head section, an intermediate section and a deformable tail section, having a longitudinal bore there through, a rod extending through the bore, a fishhook secured to the rod at the tail section, a swivel secured to the rod at the head section and a weight embedded within the body.

U.S. Pat. No. 3,426,467 discloses an improved worm or lure attachment. A buoyant head is capped over the leading end of a wriggly imitation plastic worm. A spatulate-shape oblique-angled extension on the head provides a duckbill-like diving vane. The head is provided with an axial bore freely receiving a fishing line or leader which is connected to the eye of a fish hook nested in a socket in the rear end of the head. The shank of the fish hook passes through and out of the leading portion of the imitation worm and the point of the fish hook impales the imitation worm.

U.S. Pat. No. 3,611,614 discloses a fishing lure consisting of an insect-like body member of very soft plastic having the shank portion of a fish hook molded longitudinally therein, the point and eye portions of the hook being laterally offset in the same direction from the shank to project outwardly from the plastic body, and one or more enlargements affixed to the shank and molded in the plastic body, the enlargements serving both as weights to hold the hook in a desired position in use, and to hold the plastic body in secure engagement with the hook.

U.S. Pat. No. 3,685,192 discloses a fish shaped lure of soft resilient plastic with neutral buoyancy imparting means or cavity formed therein. An alternate embodiment has a harder head section and a baffle. There are grooves or slots in the sides of the lure. A line attaching nose wire extends forwardly and a snelled hook is also attached to this nose wire. The snelled hook is detachably held along the underside of the line until a fish strikes whereupon it detaches from the underside so that the strain of the fish is taken directly to the nose wire and hence to the line.

U.S. Pat. No. 2,572,608 discloses a worm shaped lure made of rubber and having the same look and feel as that of a natural worm. A slit opening is included for the insertion of a hook. The rubber materials used by such lures to simulate the look and feel of a natural worm, however, tend to break under strain by the hook. Therefore a convenient reinforcing means is needed.

U.S. Pat. No. 5,070,639 discloses a fishing lure system comprising a rigid head and a body having a leading surface adjacent the head. The body, preferably flexible, extends rearwardly from the leading surface and removably receives a shank extending rearwardly from the head. The body has a rattle cavity with a mouth opening through the leading surface and offset from the shank. A rattle assembly, preferably longer and wider than it is high, is removably disposed in the cavity. The system may further comprise a different type of lure, such as a spoon-type lure, adapted to removably receive the same rattle assembly which is disposed in the aforementioned cavity.

U.S. Pat. No. 6,061,948 discloses a mountable head that is adapted to be fitted or coupled to a presently existing or common fishing lure, such as a worm and hook fishing lure or a fly fishing lure. The mountable head comprises a head portion having a hollow receiving chamber and attaching components coupled thereto. The attaching components are depressed or bent inwardly into the receiving chamber so that they are in engaging positions. Various colored eyes are painted on or fixedly attached to different head portions to resemble the heads and eyes of bait animals upon which fish prefer to prey. The attaching components aid in securing the head portion to a fishing lure and further aid in securing the body portion of a soft plastic animal fishing lure in place to a fishing hook, thus preventing the body portion from sliding down the shank of the hook. An eyelet access opening is provided on the head portion to allow access to the eyelet of a fishing lure hook so that a fishing line is able to be attached thereto. The mountable head allows a fishing person or angler to easily alter the appearance and attractiveness of a presently existing or common fishing lure by simply interchanging the mountable head so that the lure has a different head and eye color combination. A weight portion is coupled to the head portion.

### SUMMARY OF THE INVENTION

What the inventors have found is that the lifetime and durability of artificial baits is improved by providing an integral hook holding portion. The lure for attracting fish comprising: a main body made from a soft flexible elastomeric material in the form of a fish attracting bait; and a hook holding means holding said bait form wherein said holding means is disposed near a strategic portion of said bait form. The main body is made from a plastisol-based material such as those known in the art.

A number of materials having various flexibilities are known that can be used in production. A variety of vinyl resins and vinyl plastisols can be used in accordance with this invention, for example: low molecular weight polyvinyl chloride; medium molecular weight polyvinyl chloride; blends of low and medium molecular weight polyvinyl chloride; and equivalent vinyl plastisols. Alternatively, natural and synthetic rubbers may be used in place of the plastisol, as may thermosetting synthetic plastics.

### FIGURES

FIGS. 1-4 show several different forms of the invention, including a worm, a crab, a frog chunk, and a lizard. It should not be concluded that this invention is limited to the shown baits.

### DETAILED DESCRIPTION

The lure for attracting fish comprising: a main body made from a soft flexible elastomeric material in the form of a fish-attracting bait; and a hook holding means holding said bait form wherein the holding means is disposed in a strategic area of the bait form.

The main body is made from a plastisol material such as those materials known in the art. For instance, characteristically, these vinyl plastisols are heavily plasticized, e.g., contain from about 30 to about 65 percent by weight, based on total vinyl plastisol formulation, of a plasticizer, such as, dioctyl phthalate, dicapryl phthalate, dioctyl adipate, dioctyl sebacate, mixtures of any two or more of such plasticizers, etc. Other plasticizers and amounts of plasticizers may be used in alternative embodiments. Further, alternative natural and synthetic rubbers may be used in place of the plastisol, as may thermosetting synthetic plastics.

Stabilizers, fillers, pigments, gel thixotropic agents, solvents, flow control agents, lubricants, and other customary additives can be used in accordance with the known molding techniques of such plastisols, e.g., injection molding, rotational molding, hand pouring, etc.

The lure plastisol material may be filled with a particulate filler chosen from the particulate fillers consisting of sodium chloride, calcium chloride, calcium carbonate, and other organic and inorganic additives that increase density. These materials are incorporated or fill the plastic body of the bait form using techniques well known in the art of molding plastic objects.

Certain porous particulate fillers can be impregnated with fish attractants as well. For instance, where the attractant is a water soluble attractant, the materials can be combined with particulate powder, dried, milled, and mixed with the pre-polymer liquid, placed in the mold for the specific bait form and cured.

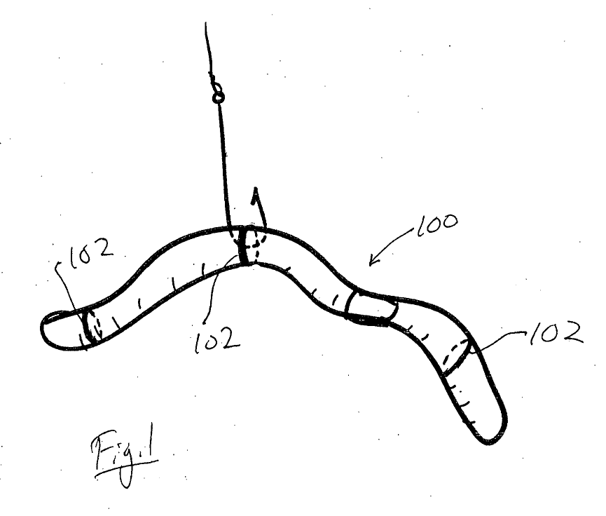

As shown in FIG. 1, the lure 100 also includes an integral hook holding means 102 that is disposed in a strategic area of the bait form. Some users prefer to hook the lure on one or both ends, whereas others prefer to hook the lure near the middle. Thus, the lure 100 may be provided with the hook holding means 102 located at or near the ends of the lure 100 or somewhere in between to accommodate the preference of different users. Further, several hook holding means 102 may be provided, as shown in FIG. 1.

The means 102 for holding the hook is typically a loop that is integral with the bait form and may resemble an o-ring. Such a loop-shaped hook holding means 102 may be a plastic, fibrous, or metal ring placed in the mold prior to injecting the plastisol for the lure 100. Alternatively, the hook holding means 102 may be a dense region of the lure 100. Such a dense region may be a denser or higher strength form of plastisol or another polymer that is compatible with plastisol. The dense region may be formed by injecting the desired amount of the alternate plastic into the mold in between the shots of plastisol. For example, for a centrally located dense region, a portion of plastisol is injected into the mold followed by a portion of the denser polymer, followed by plastisol. In such a fashion the holding means 102 allows insertion of the hook through the bait form and through the loop or dense region.

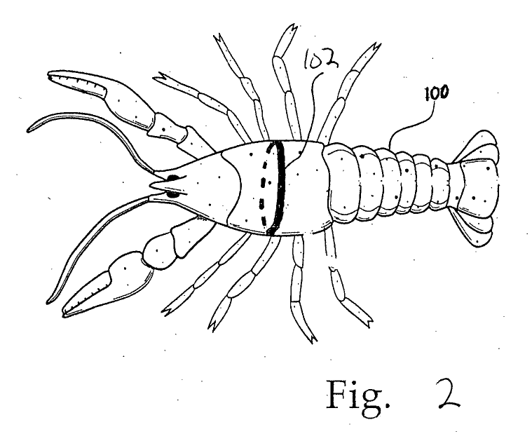

The holding means is thus molded into the article and may provide an opening through which the hook is placed when in use. An advantage of the integral holding means 102 is that it is fixed relative to the bait form and provides a durable hooking anchor that extends the life of the artificial bait in use. A further advantage of the integral hook holding means 102 is that the user is not required to use a cumbersome tool or find the correct sized o-ring to reinforce a lure. An even further advantage of the invention is that non-cylindrical lures such as the one shown in FIG. 2, may be reinforced with a hook holding means 102.

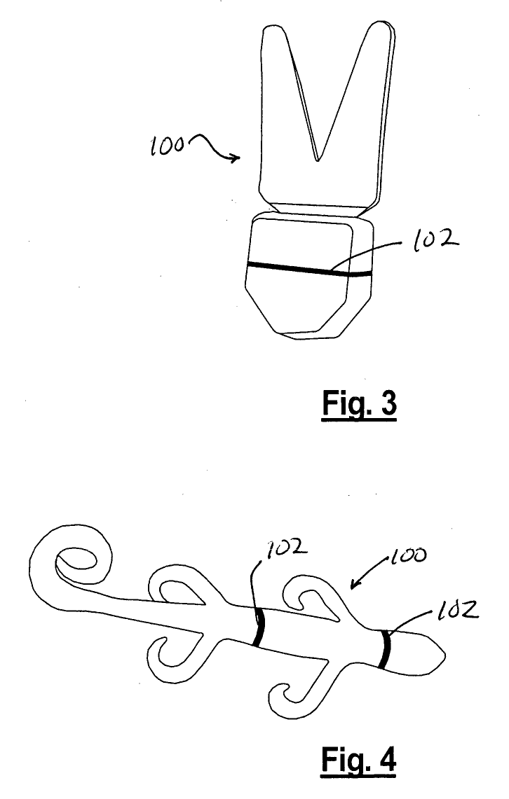

Alternatively shaped lures are shown in FIGS. 2-4. It should be noted that the invention may be applied to substantially any lure shape and the invention should not be limited to the shapes shown and described herein.

It should be further noted that the composition of the hook holding means 102 may include any natural or synthetic material such as but not limited to the following: latex rubber, natural fiber, plastics (i.e. polyvinyl chloride of a denser, more rigid nature than said bait form or nylon), or metal.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A lure for attracting fish comprising: a main body made from a soft, flexible material in the form of a fish-attracting bait; and an integral hook holding means comprising an o-ring.

2. The lure of claim 1 wherein said main body is made from a plastisol material.

3. The lure of claim 2 wherein said plastisol material is filled with a particulate filler comprising porous particles impregnated with fish attractant.

4-5. (canceled)

6. The lure of claim 1 wherein said bait form is in a shape selected from the group consisting essentially of a worm, a crayfish, a minnow, a bloodworm, a squid, a crab, a shrimp, a frog, a lizard, and a frog chunk.

7. The lure of claim 1 wherein said o-ring is molded into a central portion of said main body.

8. The lure of claim 1 wherein said o-ring is positioned proximate to an end of said main body.

9. The lure of claim 1 wherein said lure comprises a plurality of said integral holding means.

10. (canceled)

11. The lure of claim 1 where said holding means is substantially in the middle of said main body and provides an anchor for a hook so that when suspended by said hook the bait form has a first suspended bait body and a second suspended bait body and said first and said second bait body have freedom of movement about said holding means to allow movement of each.

12. (canceled)

13. The lure of claim 1 wherein said o-ring comprises a harder material than the soft, flexible material of said main body.

14. The lure of claim 13 wherein the harder material comprises a material selected from the group consisting essentially of plastic, rubber, fibrous material, latex, and latex rubber.
